(19) United States
(12) Patent Application Publication
(10) Pub. No.: US 2009/0040210 A1
(43) Pub. Date: Feb. 12, 2009

(54) Scan electrode driver for a plasma display

(76) Inventor: Sang-Gu Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/219,746

(22) Filed: Jul. 28, 2008

(30) Foreign Application Priority Data
Aug. 8, 2007 (KR) 10-2007-0079580

(51) Int. Cl. G06F 3/038

(52) U.S. Cl. 345/212; 345/211

(57) ABSTRACT

A scan electrode driver for driving a scan electrode, the scan electrode driver including a scan IC coupled between a first node and a second node, and adapted to selectively apply a first voltage and a second voltage that is lower than the first voltage to the scan electrode during an address period, a voltage regulator including a first terminal coupled to the first node, and a capacitor coupled between a second terminal of the voltage regulator and the second node, wherein the voltage regulator is adapted to charge the capacitor with a third voltage that is lower than a voltage difference between the first voltage and the second voltage before the second voltage is applied to the scan electrode.

### BACKGROUND OF THE INVENTION

1. Field of the Invention

Embodiments relate to a scan electrode driver for a plasma display device. More particularly, embodiments relate to a scan electrode driver for a plasma display device having improved contrast, capable of operating with a relatively lower reset maximum voltage, and capable of operating without an additional power source.

2. Description of the Related Art

A plasma display device is a flat panel display that uses plasma generated by a gas discharge to display characters or images. It includes a plasma display panel (PDP) wherein a plurality of discharge cells (hereinafter referred to as cells) are arranged in a matrix format, the number thereof depending on its size.

According to a typical driving method of a PDP, each frame is divided into a plurality of subfields having respective weights, and grayscales are expressed by a combination of weights of the subfields, which are used to perform a display operation. Each subfield is divided into a reset period, an address period, and a sustain period and then driven. A wall charge state of a discharge cell is initialized during the reset period, turn-on cells are selected during the address period, and a sustain discharge operation is performed in the turn-on cells for displaying an image during the sustain period.

In general, the voltage of a scan electrode is gradually increased to a reset maximum voltage, and is then gradually decreased to a reset minimum voltage to initialize discharge cell during a reset period. However, if the reset maximum voltage is set too high, the quantity of reset discharge is increased. This may lead to deterioration in the contrast of the plasma display. Furthermore, an additional power source for supplying the reset maximum voltage is needed to increase the voltage of the scan electrode to the reset maximum voltage.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

Embodiments of the invention are therefore directed to scan electrode driver employable in a plasma display device, which substantially overcome one or more of the problems due to the limitations and disadvantages of the related art.

It is therefore a feature of an embodiment of the invention to provide a scan electrode driver adapted to lower a reset maximum voltage.

It is therefore a separate feature of an embodiment of the invention to provide a plasma display employing such a scan electrode driver and accordingly having improved contrast.

At least one of the above and other features and advantages of the inventio may be realized by providing a scan electrode driver for driving a scan electrode of a plasma display, the scan electrode driver, including a scan IC coupled between a first node and a second node, and adapted to selectively apply a first voltage and a second voltage that is lower than the first voltage to the scan electrode during an address period, a zener diode including a cathode coupled to the first node, and a capacitor coupled between an anode of the zener diode and the second node.

The capacitor may be charged with a third voltage that is lower than a voltage difference between the first voltage and the second voltage before the second voltage is applied to the scan electrode.

The third voltage may be lower than the voltage difference between the first voltage and the second voltage by a withstand voltage of the zener diode.

The scan electrode driver may include a first transistor coupled to the second node and a power source that supplies the second voltage, wherein the first node may be coupled to a power source that supplies the first voltage.

The scan electrode driver may include a second transistor coupled between a power source that supplies a fourth voltage that is higher than the second voltage and the second node, and that is turned on to gradually increase a voltage of the scan electrode during a reset period.

The fourth voltage may be a high level voltage of a sustain pulse applied to the scan electrode during a sustain period.

The plasma display may include a third transistor coupled between the second node and a power source that supplies a voltage that is lower than the fourth voltage, and is turned on to gradually decrease a voltage of the scan electrode during a reset period.

The second transistor may be turned on to gradually increase a voltage of the scan electrode to a voltage that is equal to a sum of the third voltage and the fourth voltage during the reset period.

The zener diode may act as a standard diode during the reset period.

During the address period, the first transistor may be turned on, and a voltage difference between a cathode and an anode of the zener diode may correspond to a withstand voltage of the zener diode.

At least one of the above and other features and advantages of the invention may be separately realized by providing a scan electrode driver for driving a scan electrode of a plasma display, the scan electrode driver including a scan IC coupled between a first node and a second node, and adapted to selectively apply a first voltage and a second voltage that is lower than the first voltage to the scan electrode during an address period, a first transistor including a first end coupled to the first node, a capacitor coupled between a second end of the first transistor and the second node, a first resistor coupled to the first end of the first transistor and a control electrode of the first transistor, and a second resistor coupled to the control electrode of the first transistor and the second end of the first transistor.

The capacitor may be charged with a third voltage that is lower than a voltage difference between the first voltage and the second voltage before the second voltage is applied to the scan electrode.

The first transistor may be a MOS (metal oxide semiconductor) field effect transistor.

The scan electrode driver may include a diode including a cathode coupled to the first end of the first transistor and an anode coupled to the second end of the first transistor, wherein the first transistor may be one of a bipolar transistor and an insulated gate bipolar transistor.

The scan electrode driver may include a second transistor coupled between the second node and a power source that supplies the second voltage, wherein the first node is coupled to a power source that supplies the first voltage.

The scan electrode driver may include a third transistor coupled between a power source that supplies a fourth voltage that is higher than the second voltage and the second node, and that is turned on to gradually increase a voltage of the scan electrode during a reset period.

The fourth voltage may be a high level voltage of a sustain pulse applied to the scan electrode during a sustain period.

The third transistor may be turned on to gradually increase a voltage of the scan electrode to a voltage that is equal to a sum of the third voltage and the fourth voltage during the reset period.

The scan electrode driver may include a fourth transistor coupled between the second node and a power source that supplies a voltage that is lower than the fourth voltage, and that is turned on to gradually decrease a voltage of the scan electrode during a reset period.

At least one of the first resistor and the second resistor may be a variable resistor.

At least one of the above and other features and advantages of the invention may be separately realized by providing a scan electrode driver for driving a scan electrode of a plasma display, the scan electrode driver including a scan IC coupled between a first node and a second node, and adapted to selectively apply a first voltage and a second voltage that is lower than the first voltage to the scan electrode during an address period, a voltage regulator including a first terminal coupled to the first node, and a capacitor coupled between a second terminal of the voltage regulator and the second node, wherein the voltage regulator is adapted to charge the capacitor with a third voltage that is lower than a voltage difference between the first voltage and the second voltage before the second voltage is applied to the scan electrode.

The voltage regulator may be one of a zener diode and a voltage multiplier.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a block diagram of a plasma display device according to an exemplary embodiment of the present invention;

FIG. 2 illustrates an exemplary driving waveform diagram of a plasma display device according to an exemplary embodiment of the present invention;

FIG. 3 illustrates a scan electrode driver according to an exemplary embodiment of the present invention;

FIG. 4A to FIG. 4E illustrate current paths in the scan electrode driver of FIG. 3;

FIG. 5 illustrates a scan electrode driver according to another exemplary embodiment of the present invention; and

FIG. 6 illustrates a circuit diagram of the multiplier of FIG. 5 including exemplary current paths.

### DETAILED DESCRIPTION OF THE INVENTION

Korean Patent Application No. 10-2007-0079580, filed on Aug. 8, 2007, in the Korean Intellectual Property Office, and entitled: “Plasma Display,” is incorporated by reference herein in its entirety.

In the following detailed description, exemplary embodiments of the present invention have been illustrated and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through other element(s), e.g., a third element. In addition, unless explicitly described to the contrary, the word “comprise” and variations such as “comprises” or “comprising” will be understood to imply the inclusion of stated elements but not the exclusion of any other elements.

The wall charges being described in the present invention are charges formed on a wall, e.g., a dielectric layer, close to each electrode of a discharge cell. The wall charges will be described as being “formed” or “accumulated” on the electrode, although the wall charges do not actually touch the electrodes. Further, a wall voltage is a potential difference formed on the wall of the discharge cell by the wall charges.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. Furthermore, the threshold voltage of a semiconductor element, e.g., a transistor or a diode, is disregarded, because the threshold voltage of the semiconductor element is much lower than the discharge voltage.

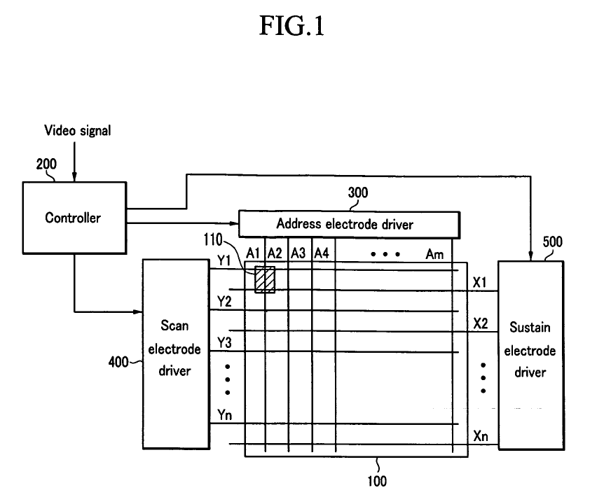

FIG. 1 illustrates a block diagram of a plasma display device according to an exemplary embodiment of the present invention.

As illustrated in FIG. 1, the plasma display device according to the exemplary embodiment of the present invention may include a plasma display panel (PDP) 100, a controller 200, an address electrode driver 300, a scan electrode driver 400, and a sustain electrode driver 500.

The PDP 100 may include a plurality of address electrodes A1 to Am extending in a column direction, a plurality of sustain electrodes X1 to Xn extending in a row direction, and a plurality of scan electrodes Y1 to Yn extending in the row direction. Generally, the sustain electrodes X1 to Xn may correspond to the respective scan electrodes Y1 to Yn, and respective ends thereof may be coupled to each other.

The PDP 100 may include a substrate on which the sustain and scan electrodes X1 to Xn and Y1 to Yn are arranged (not illustrated), and another substrate on which the address electrodes A1 to Am are arranged (not illustrated). The two substrates may be placed facing each other with a discharge space therebetween such that the scan electrodes Y1 to Yn and the address electrodes A1 to Am may cross, e.g., perpendicularly overlap, each other and the sustain electrodes X1 to Xn and the address electrodes A1 to Am may cross, e.g., perpendicularly overlap, each other. Discharge spaces formed at respective crossing regions of the address electrodes A1 to Am and the sustain and scan electrodes X1 to Xn and Y1 to Yn correspond to discharge cells 110. This is an exemplary structure of the PDP 100. Embodiments of the invention are not limited thereto, e.g., one or more aspects of the invention may be applied to panels including other structures and/or arrangements.

The controller 200 may receive external video signals and may output address electrode driving control signal(s), sustain electrode driving control signal(s), and scan electrode driving control signal(s). The controller 200 may divide one frame into a plurality of subfields and may drive the subfields. Each subfield may include a reset period, an address period, and a sustain period with respect to time.

The address electrode driver 300 may receive the address electrode driving control signal from the controller 200. The address electrode driver 300 may apply a display data signal to each address electrode so as to select a discharge cell to be displayed.

The scan electrode driver 400 may receive the scan electrode driving control signal from the controller 200. The scan electrode driver 400 may apply a driving voltage to a scan electrode Y.

The sustain electrode driver 500 may receive the sustain electrode driving control signal from the controller 200. The sustain electrode driver 500 may apply a driving voltage to a sustain electrode X.

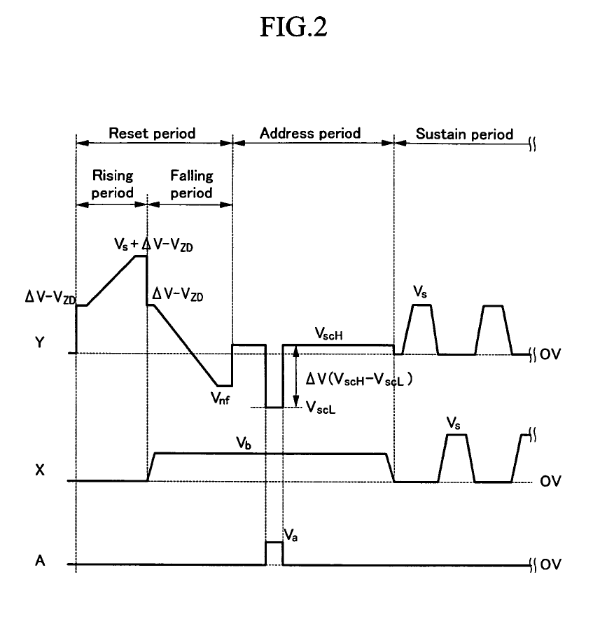

Driving waveforms according to an exemplary embodiment of the present invention will be described with reference to FIG. 2.

FIG. 2 illustrates an exemplary driving waveform diagram of a plasma display device according to an exemplary embodiment of the present invention.

In the following, only driving waveforms applied to a scan electrode (hereinafter referred to as a Y electrode), a sustain electrode (hereinafter referred to as an X electrode), and an address electrode (hereinafter referred to as an A electrode) forming a single discharge cell will be described for better understanding and ease of description.

The reset period will now be described. The reset period may include a rising period and a falling period.

During the rising period, a voltage of the Y electrode may be gradually increased from a ΔV−V_{ZD} voltage to a reset maximum voltage Vₛ+ΔV−V_{ZD} while the A electrode and the X electrode may be maintained at a reference voltage, i.e., 0V in FIG. 2.

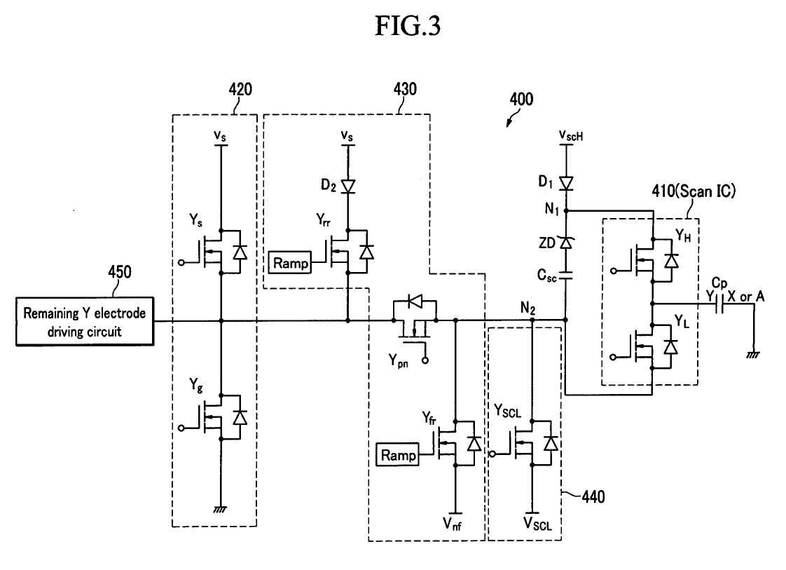

Referring to FIG. 2, a V_{S} voltage may be a higher voltage of two voltages that may be applied to the Y electrode or X electrode during a sustain period. A ΔV voltage may be equal to a voltage difference between a non-scan voltage V_{scH} and a scan voltage V_{scL}. Furthermore, a V_{ZD} voltage may be a withstand voltage of a zener diode ZD described below with reference to FIG. 3. Although it is illustrated in FIG. 2 that the voltage of the scan electrode Y may decrease or increase in a ramp pattern, embodiments of the invention are not limited thereto. For example, in some embodiments, another type of waveform that gradually increases or decreases may be applied. Although it is illustrated in FIG. 2 that the voltage of the Y electrode is increased from the ΔV−V_{ZD} voltage to the reset maximum voltage, the voltage of Y electrode may be increased to the reset maximum voltage from a different voltage, i.e., a reference voltage.

The increase in the voltage of the scan electrode Y may trigger a weak discharge between the scan electrode Y and the sustain electrode X and between the scan electrode Y and the address electrode A. As a result, negative (−) wall charges may be formed on the scan electrode Y and positive (+) wall charges may be formed on the sustain electrode X and the address electrode A. In some embodiments, all cells are to be initialized during the reset period, and accordingly, the reset maximum voltage Vₛ+ΔV−V_{ZD} may be set to a voltage that is high enough to generate a discharge in all cells under any condition. In some embodiments, because the reset maximum voltage may be set to be as low as the V_{S}+ΔV−V_{ZD} voltage, a plasma display employing one or more aspects of the invention may not require an additional power source.

During the falling period, the voltage of the Y electrode is gradually decreased from the ΔV−V_{ZD} voltage to a V_{nf} voltage while the A electrode and the X electrode are respectively maintained at the reference voltage and the V_{b} voltage. The decrease in the voltage of the Y electrode may trigger a weak discharge between the Y electrode and the X electrode and between the Y electrode and the A electrode. As a result, negative (−) wall charges formed on the Y electrode and positive (+) wall charges formed on the X electrode and the A electrode may be erased. In general, a magnitude of the V_{nf}−V_{b} voltage may be set close to a discharge firing voltage between the Y electrode and the X electrode, and therefore a wall voltage difference between the Y electrode and the X electrode may be close to 0V such that misfiring of cells that have been addressed during the address period may be reduced and/or prevented during a sustain period.

The wall charge between the Y electrode and the A electrode may be set by the V_{nf} voltage, because the voltage of the A electrode may be set to the reference voltage. Although it is illustrated in FIG. 2 that the voltage of the Y electrode is decreased from the ΔV−V_{ZD} voltage to the V_{nf} voltage, embodiments of the invention are not limited thereto. For example, in some embodiments, the voltage of the Y electrode may be decreased to the V_{nf} voltage from a different voltage, i.e., the reference voltage.

During the address period, a scan pulse having a V_{scL} voltage may be sequentially applied to a plurality of Y electrodes Y1-Yn while the V_{b} voltage may be applied to the X electrode so as to select light emitting cells. Simultaneously, an address voltage Vₐ may be applied to an A electrode that selects light emitting cells among a plurality of cells associated with the Y electrode. A Y electrode, to which the scan voltage V_{scL} is not applied, may be applied with a non-scan voltage V_{scH} that is higher than the scan voltage V_{scL}. The reference voltage may be applied to an A electrode of an unselected discharge cell. The ΔV voltage may be a voltage difference between the non-scan voltage V_{scH} and the scan voltage V_{scL}, as illustrated in FIG. 2.

During the sustain period, a sustain pulse alternately having a high level voltage (Vₛ voltage in FIG. 2) and a low level voltage (0V in FIG. 2) may be applied to the scan electrode Y and the sustain electrode X. A sustain pulse applied to the scan electrode Y may be opposite in phase to a sustain pulse applied to the sustain electrode X.

Accordingly, an address discharge may be generated between the address electrode A to which the address voltage Vₐ was applied and the scan electrode Y to which the V_{scL} voltage was applied and between the scan electrode Y to which the V_{scL} voltage was applied and a sustain electrode X corresponding to the scan electrode Y to which the address voltage Vₐ was applied. Thus, positive wall charges may be formed on the scan electrode Y and negative wall charges may be formed on the address electrode A and the sustain electrode X. Referring to FIG. 2, in some embodiments, by setting the scan voltage V_{scL} to be lower than the reset minimum voltage V_{nf}, address discharge may be stably generated.

To perform addressing operations, the scan electrode driver 400 may select a Y electrode among a plurality of Y electrodes Y1-Yn to which a scan pulse is to be applied during the address period. For example, the scan electrode driver 400 may be set to select Y electrodes sequentially according to an arrangement order in a vertical direction. When a Y electrode is selected, the address electrode driver 300 may select a turn-on cell(s) among discharge cells associated with the selected Y electrode. That is, the address electrode driver 300 may select a discharge cell(s) by supplying the address pulse Vₐ is applied among the plurality of A electrodes A1-An.

During the sustain period, a sustain pulse alternately having a high level voltage (Vₛ in FIG. 2) and a low level voltage (0V in FIG. 2) may be applied to the scan electrode Y and the sustain electrode X. Accordingly, the 0V voltage may be applied to the sustain electrode X when the Vₛ voltage is applied to the scan electrode Y, the 0V voltage may be applied to the scan electrode Y when the Vₛ voltage is applied to the sustain electrode X. Thus, a discharge may be generated between the scan electrode Y and the sustain electrode Y by a wall voltage and the Vₛ voltage. The wall voltage may be formed between the scan electrode Y and the sustain electrode X due to the address discharge and the Vₛ voltage. Processes for applying the sustain pulse to the scan electrode Y and the sustain electrode X may be repeated a number of times based on a weight of the corresponding subfield.

FIG. 3 illustrates the scan electrode driver 400 according to an exemplary embodiment of the present invention. In some embodiments, the scan electrode driver 400 may generate the exemplary Y electrode driving waveform illustrated in FIG. 2.

As illustrated in FIG. 3, the exemplary scan electrode driver 400 may include a plurality of scan ICs 410, a sustain pulse generator 420, a reset waveform generator 430, a scan voltage generator 440, a capacitor C_{sc}, a zener diode ZD, and a remaining Y electrode driving circuit 450.

In FIG. 3, each transistor is illustrated as an n-channel field effect transistor, e.g., an NMOS (n-channel metal oxide semiconductor) transistor having a body diode (not illustrated). However, embodiments are not limited thereto. For example, one, some or all of the n-channel transistors may be replaced with a switch having the same or similar functions, or each transistor in FIG. 3 may be replaced with a plurality of transistors coupled in parallel.

In FIG. 3, a capacitive component formed by the A electrode and the Y electrode is indicated as a panel capacitor Cp. In the following description, it is assumed that the reference voltage is applied to the X electrode or A electrode for better understanding and ease of description.

Each one of a plurality of scan ICs 410 may include a transistor Y_{H} and a transistor Y_{L}, and each scan IC 410 may correspond to a Y electrode. In FIG. 3, a scan IC 410 corresponding to a Y electrode is illustrated for better understanding and ease of description.

A source of the transistor Y_{H} and a drain of the transistor Y_{L} may be mutually coupled at a common node, and the common node of the transistor Y_{H} and the transistor Y_{L} may be coupled to the corresponding Y electrode. A drain of the transistor Y_{H} may be coupled to a first node N₁ of the capacitor C_{sc}, and a source of the transistor Y_{L} may be coupled to a second node N₂ thereof.

The sustain pulse generator 420 may include transistors Yₛ and Y_{g}. A drain of the transistor Yₛ may be coupled to the power source that supplies the Vₛ voltage. A drain of the transistor Y_{g} may be coupled to a source of the transistor Yₛ, and a source of the transistor Y_{g} may be coupled to ground. The sustain pulse generator 420 may apply a high level voltage Vₛ and a low level voltage (0V) of the sustain pulse to the Y electrode during the sustain period. In other words, during a sustain period, the Vₛ voltage may be applied to the scan electrode as the transistor Yₛ is turned on and the reference voltage may be applied to the scan electrode as the transistor Y_{g} is turned on.

The reset waveform generator 430 may include transistors Yᵣᵣ, Y_{fr}, and Yₚₙ, and a diode D₂.

An anode of the diode D₂ may be coupled to a power source Vₛ that supplies the Vₛ voltage, and a drain of the transistor Yᵣᵣ may be coupled to a cathode of the diode D₂. A drain of the transistor Yₚₙ may be coupled to a source of the transistor Yᵣᵣ. A drain of the transistor Y_{fr} may be coupled to a source of the transistor Yₚₙ, and a source of the transistor Y_{fr} may be coupled to a power source V_{nf} that supplies the V_{nf} voltage. In some embodiments, the transistor Yᵣᵣ and the transistor Y_{fr} may each operate as ramp switches that gradually increase the voltage of the Y electrode by passing a constant current to the Y electrode when turned on. Ramp circuits may be coupled to driving circuits of the transistors Yᵣᵣ and Y_{fr} to allow the transistors Yᵣᵣ and Y_{fr} to operate as ramp switches. The diode D₂ may only allow one-directional current flow from a power source Vₛ that applies the Vₛ voltage to the transistor Yᵣᵣ. The transistor Yₚₙ may prevent current flow through a body diode of the transistor Y_{g} when the transistor Y_{fr} or the transistor Y_{SCL} is turned on.

The scan voltage generator 440 may include the transistor Y_{SCL}. A drain of the transistor Y_{SCL} may be coupled to the second node N₂, and a source of the transistor Y_{SCL} may be coupled to a power source V_{scL} that supplies the V_{scL} voltage.

An anode of a diode D₁ may be coupled to a power supply V_{scH} that supplies the non-scan voltage V_{scH}, and a cathode of the zener diode ZD may be coupled to a cathode of the diode D₁. One end of the capacitor C_{sc} may be coupled to an anode of the zener diode ZD, and another end of the capacitor C_{sc} may be coupled to the second node N₂. In some embodiments, the zener diode ZD of the scan electrode driver 400 according to the first exemplary embodiment of the present invention may act as a standard diode to flow current in one direction, and as a zener diode to simultaneously generate a withstand voltage V_{ZD}.

In other words, the zener diode ZD may act as a zener diode when a voltage of one end of the capacitor C_{sc} is lower than the V_{scH} voltage, and the zener diode ZD may act as a standard diode when the voltage of the one end of the capacitor C_{sc} is higher than the V_{scH} voltage. The diode D₁ may allow only one-directional current flow from the power source V_{scH} to the first node N₁.

The remaining Y electrode driving circuit 450 may be coupled to the drain of the transistor Yₚₙ, and may generate several driving waveforms that may be applied to the Y electrode. For example, the remaining Y electrode driving circuit 450 may include an energy recovery circuit. The constitution of the remaining Y electrode driving circuit 450 is not directly related to the present invention, and accordingly detailed description thereof is omitted.

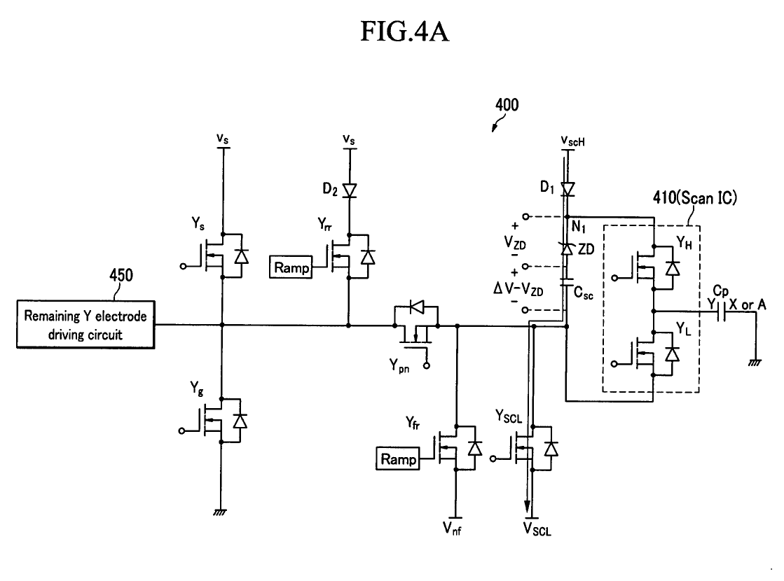

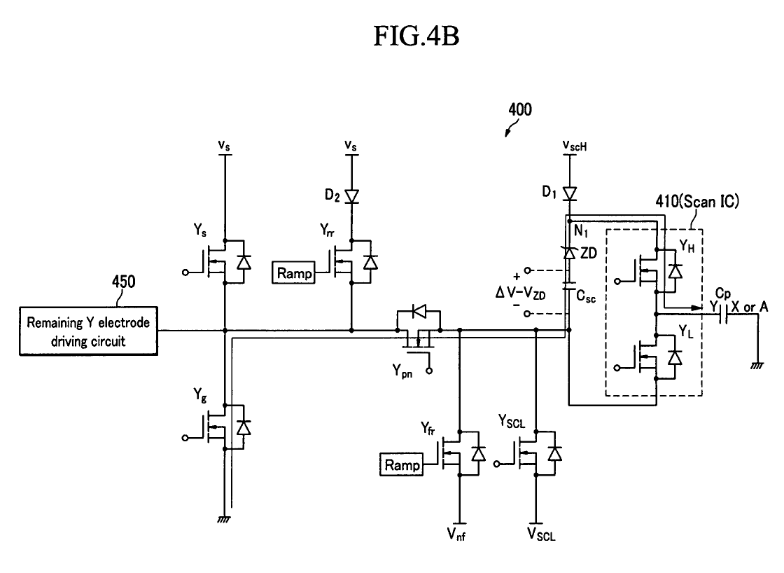

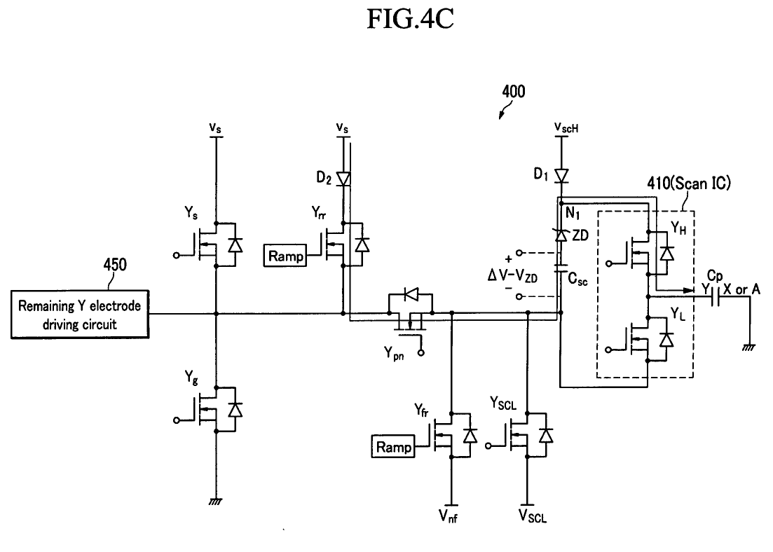

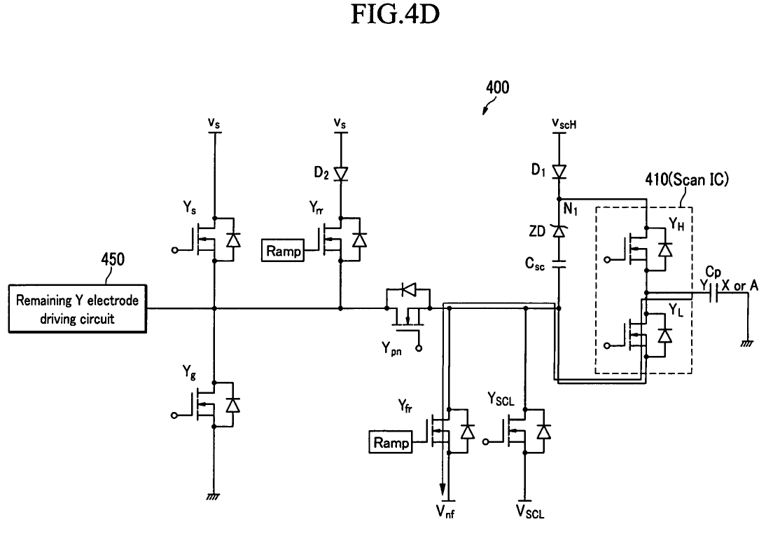

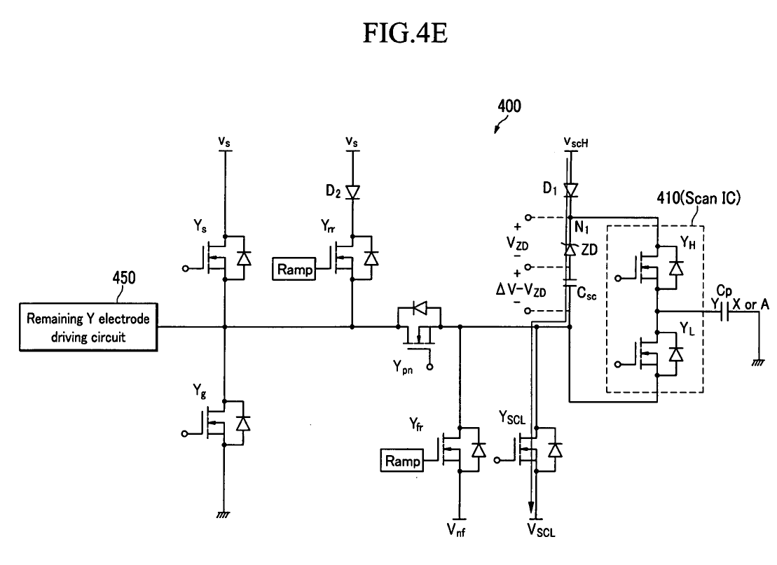

An exemplary method for generating a driving waveform of the Y electrode, as illustrated in FIG. 2, using the scan electrode driver 400 according to the first exemplary embodiment of the present invention, will now be described with reference to FIGS. 4A to 4E.

FIGS. 4A to 4E illustrate exemplary current paths in the scan electrode driver 400 according to the first exemplary embodiment of the present invention.

Referring to FIG. 4A, it is assumed that the transistor Y_{SCL} is turned on before the reset period. As the transistor Y_{SCL} is turned on, a current path may be formed from the power source V_{scH} that supplies the V_{scH} voltage to the power source V_{scL} that supplies the V_{scL} voltage by way of the diode D₁, the zener diode ZD, the capacitor C_{sc}, and the transistor Y_{scL}. When such a current path is formed, the zener diode ZD may act as a zener diode, and may generate a voltage difference between the cathode and the anode of the zener diode ZD by a withstand voltage. In this way, a ΔV−V_{ZD} (i.e., V_{scH}−V_{scL}−V_{ZD}) voltage may be charged in the capacitor C_{sc}.

Referring to FIGS. 2 and 4B, the transistors Y_{g}, Yₚₙ, and Y_{H} may be turned on at the beginning of the rising period of the reset period.

As the transistors Y_{g}, Yₚₙ, and Y_{H} are turned on, a current path may be formed from ground through the transistor Yₚₙ, the capacitor C_{sc}, the zener diode ZD, and the transistor Y_{H} to the Y electrode. In this case, the capacitor C_{sc} may still be charged with the ΔV−V_{ZD} voltage, and accordingly the voltage of one end of the capacitor C_{sc} may be lower than the V_{scH} voltage. In this way, the zener diode ZD may act as a standard diode, and accordingly the ΔV−V_{ZD} voltage may be applied to the Y electrode.

Referring to FIGS. 2 and 4C, the transistors Yᵣᵣ, Yₚₙ, and Y_{H} may be turned on during the rising period of the reset period. As the transistors Yᵣᵣ, Yₚₙ, and Y_{H} are turned on, a current path may be formed from the power source Vₛ through the diode D₂, the transistor Yᵣᵣ, the transistor Yₚₙ, the capacitor C_{sc}, the zener diode ZD, and the transistor Y_{H} to the Y electrode. When forming this current path, the zener diode ZD acts as a standard diode, and accordingly the voltage of the Y electrode may be gradually increased from the ΔV−V_{ZD} voltage to a Vₛ+ΔV−V_{ZD} voltage.

If the scan electrode driver 400 does not include the zener diode ZD, the voltage of the Y electrode may be increased to the ΔV+Vₛ voltage. Accordingly, by including the zener diode ZD, the reset maximum voltage may be lowered to the Vₛ+ΔV−V_{ZD} voltage.

The transistors Y_{g} , Yₚₙ, and Y_{H} may be turned on at the beginning of the falling period of the reset period. Referring back to FIGS. 2 and 4B, as the transistors Y_{g} , Yₚₙ, and Y_{H} are turned on, the ΔV−V_{ZD} voltage may be applied to the Y electrode. On the contrary, the transistors Y_{g} , Yₚₙ, and Y_{L} could be turned on, and the reference voltage may be applied to the Y electrode at the beginning of the falling period of the reset period.

Referring to FIGS. 2 and 4D, the transistors Y_{fr} and Y_{L} may be turned on during the falling period of the reset period. As the transistors Y_{fr} and Y_{L} are turned on, a current path may be formed from the Y electrode through the transistor Y_{L} and the transistor Y_{fr} to the power source V_{nf} that supplies the V_{nf} voltage. As current flows along this current path, a voltage of the Y electrode may be gradually decreased to the V_{nf} voltage.

Referring to FIGS. 2 and 4E, the transistor Y_{SCL} may be turned on during the address period. As the transistor Y_{SCL} is turned on, a current path may be formed from the power source V_{scH} that supplies the V_{scH} voltage through the diode D₁, the zener diode ZD, the capacitor C_{sc}, and the transistor Y_{SCL} to the power source V_{scL} that supplies the V_{scL} voltage. When this current path is formed, the zener diode ZD may act as a zener diode, and accordingly, a voltage difference between the cathode and the anode of the zener diode ZD is set by a withstand voltage. In this way, the V_{scH} voltage may be applied to the first node N₁, and the V_{scL} voltage may be applied to the second node N₂.

The transistor Y_{L} may be turned on when the scan voltage V_{scL} is applied to the Y electrode, and the transistor Y_{H} may be turned on when the non-scan voltage V_{scH} is applied to the Y electrode. The zener diode ZD may act as a zener diode, and the scan voltage V_{scL} and the non-scan voltage V_{scH} may be applied to the Y electrode during the address period according to the exemplary embodiment of the present invention illustrated in FIG. 2.

The transistors Yₛ, Yₚₙ, and Y_{L} and the transistors Y_{g}, Yₚₙ, and Y_{L} are alternately turned on, and the Vₛ voltage and the reference voltage are alternately applied to the Y electrode.

In accordance with the exemplary embodiment of the invention illustrated in FIGS. 4A to 4E, the reset maximum voltage may be lowered by including the zener diode ZD coupled between the first node N₁ and the one end of the capacitor C_{sc}. Accordingly, some embodiments of the invention may enable contrast of the plasma display panel to be improved.

In some embodiments, the scan voltage V_{scH} and the non-scan voltage V_{scL} may not fluctuate because the zener diode ZD may act as a zener diode during the address period.

In some embodiments, the reset maximum voltage may be set to be applied to the Y electrode from the power source Vₛ that supplies the high level voltage of the sustain pulse. In such embodiments, e.g., no additional power source is needed to supply the reset maximum voltage. In some embodiments, a zener diode may be included in a scan electrode driver, contrast of a plasma display panel including such a scan electrode driver may not be lowered even if a level of a Vₛ voltage is set higher than a predetermined value.

In some embodiments, the zener diode ZD may be replaced with another element having the same or similar functions, e.g., same or similar voltage regulating functions. For example, in some embodiments, a multiplier may be employed instead of a zener diode.

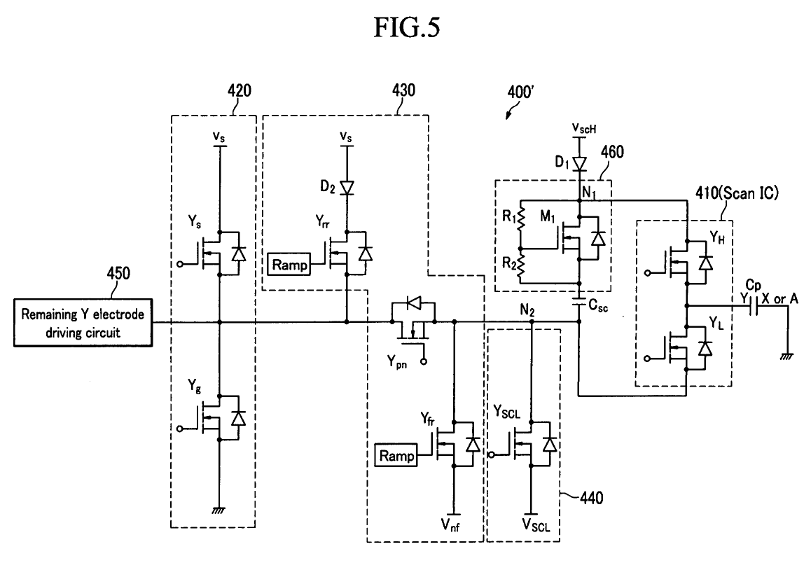

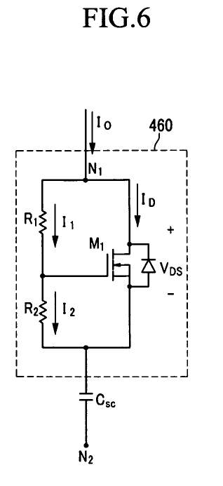

An exemplary embodiment of the invention including a multiplier instead of the zener diode ZD will now be described with reference to FIG. 5 and FIG. 6.

FIG. 5 illustrates a scan electrode driver 400 according to another exemplary embodiment of the present invention. FIG. 6 illustrates a circuit diagram of the multiplier 460 of FIG. 5 including exemplary current paths.

In general, only differences between the exemplary scan electrode driver 400′ illustrated in FIG. 5 and the exemplary scan electrode driver 400 illustrated in FIG. 3 will be described below. More particularly, the scan electrode driver 400′ substantially corresponds to the scan electrode driver 400, except that the zener diode ZD thereof is replaced by the multiplier 460.

The multiplier 460 may include a transistor M₁ and resistors R₁ and R₂. Here, the transistor M₁ may be formed as a metal-oxide semiconductor field effect transistor (hereinafter referred to as a MOSFET). The multiplier 460 may include a body diode V_{DS}.

A drain of the transistor M₁ may be coupled to a first node N₁, and a source of the transistor M₁ may be coupled to one end of the capacitor C_{sc}. One end of the resistor R₁ may be coupled to the drain of the transistor M₁, and the other end of the resistor R₁ may be coupled to a gate of the transistor M₁. One end of the resistor R₂ may be coupled to the gate of the transistor M₁, and the other end of the resistor R₂ may be coupled to the source of the transistor M₁. More particularly, referring to FIG. 5, in some embodiments, the resistor R₁ and the resistor R₂ may be connected at a common node coupled to the gate of the transistor M₁.

Referring to FIG. 6, in the case that a current Iₒ is small, the transistor M₁ may be turned off, and accordingly the current Iₒ may flow through the resistors R₁ and R₂. When the current Iₒ is high enough to turn on the transistor M₁, the current Iₒ may flow through the resistors R₁ and R₂ and the transistor M₁ simultaneously. Equation 1 sets forth a drain-source voltage V_{DS} of the transistor M₁ when the current Iₒ flows through the resistors R₁ and R₂ and the transistor M₁ simultaneously.

V_{DS}=I₁*R₁+I₂*R₂ (Equation 1)

If it is assumed that no current flows to the gate of the transistor M₁, then a current I₁ becomes equal to a current I₂ (I₁=I₂). Furthermore, the current I₂ is equal to V_{GS}/R₂ (I₂=V_{GS}/R₂). Accordingly, the drain-source voltage V_{DS} of the transistor M₁ may be illustrated by Equation 2.

V_{DS}=(1+R₁/R₂)*V_{GS} (Equation 2)

Here, the drain-source voltage V_{DS} of the transistor M₁ may correspond to the withstand voltage V_{ZD} of the zener diode ZD of the embodiment illustrated in FIG. 3.

Referring to Equation 2, the drain-source voltage V_{DS} of the transistor M₁ may be proportional to the gate-source voltage V_{GS} of the transistor M₁. The drain-source voltage V_{DS} of the transistor M₁ may be proportional to the resistance values of the resistors R₁ and R₂ are modified.

That is, the multiplier 460 may generate a voltage corresponding to the withstand voltage V_{ZD} of the zener diode ZD of FIG. 3. The resistance values of the resistors R₁ and R₂ and the gate-source voltage V_{GS} of the transistor M₁ may determine the drain-source voltage V_{DS} of the transistor M₁. Although the gate-source voltage V_{GS} of the transistor M₁ is predetermined, the drain-source voltage V_{DS} of the transistor M₁ could be determined by modifying the resistance values of the resistors R₁ and R₂. That is, in some embodiments, by only modifying the resistance values of the resistors R₁ and R₂, the reset maximum voltage may be changed and/or optimized.

In some embodiments, the resistors R₁ and R₂ may be fixed resistors, i.e., have fixed resistance values, as shown in FIGS. 5 and 6. However, embodiments are not limited thereto. For example, in some embodiments, the resistors R₁ and R₂ may be variable resistors, i.e., resistance values thereof may be modified after the process of manufacture.

A body diode V_{DS} may be formed between the drain and source of the transistor M₁. The body diode V_{DS} may be turned on if the voltage of the one end of the capacitor C_{sc} is higher than the V_{scH} voltage. In some embodiments, the multiplier 460 may act as a zener diode. That is, in some embodiments, the multiplier 460 of FIG. 5 may have very similar functions as that of the zener diode ZD of FIG. 3.

Although the transistor M₁ is illustrated as a MOSFET in FIG. 5 and FIG. 6, embodiments are not limited thereto. For example, the transistor M₁ may be a bipolar transistor or an insulated gate bipolar transistor. In some embodiments in which, e.g., the transistor M₁ is a bipolar transistor or an insulated gate bipolar transistor, because a bipolar transistor or an insulated gate bipolar transistor do not include a body diode, an additional diode having the same function as the body diode V_{DS} of the MOSFET must be employed. If the transistor M₁ is replaced with a bipolar transistor, the V_{GS} may correspond to the V_{BE} (base-emitter voltage). If the transistor M₁ is replaced with an insulated gate bipolar transistor, the V_{GS} may correspond to the V_{GE} (gate-emitter voltage). A detailed description on the transistor M₁ is omitted because it is well known to a person of ordinary skill in the art.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A scan electrode driver for driving a scan electrode of a display device, the scan electrode driver comprising:
a scan IC coupled between a first node and a second node, and adapted to selectively apply a first voltage and a second voltage that is lower than the first voltage to the scan electrode during an address period;
a zener diode including a cathode coupled to the first node; and
a capacitor coupled between an anode of the zener diode and the second node.

2. The scan electrode driver as claimed in claim 1, wherein the capacitor is charged with a third voltage that is lower than a voltage difference between the first voltage and the second voltage before the second voltage is applied to the scan electrode.

3. The scan electrode driver as claimed in claim 2, wherein the third voltage is lower than the voltage difference between the first voltage and the second voltage by a withstand voltage of the zener diode.

4. The scan electrode driver as claimed in claim 1, further comprising a first transistor coupled to the second node and a power source that supplies the second voltage,
wherein the first node is coupled to a power source that supplies the first voltage.

5. The scan electrode driver as claimed in claim 4, further comprising a second transistor coupled between a power source that supplies a fourth voltage that is higher than the second voltage and the second node, and that is turned on to gradually increase a voltage of the scan electrode during a reset period.

6. The scan electrode driver as claimed in claim 5, wherein the fourth voltage is a high level voltage of a sustain pulse applied to the scan electrode during a sustain period.

7. The scan electrode driver as claimed in claim 5, further comprising a third transistor coupled between the second node and a power source that supplies a voltage that is lower than the fourth voltage, and is turned on to gradually decrease a voltage of the scan electrode during a reset period.

8. The scan electrode driver as claimed in claim 5, wherein the second transistor is turned on to gradually increase a voltage of the scan electrode to a voltage that is equal to a sum of the third voltage and the fourth voltage during the reset period.

9. The scan electrode driver as claimed in claim 8, wherein the zener diode acts as a standard diode during the reset period.

10. The scan electrode driver as claimed in claim 4, wherein, during the address period, the first transistor is turned on, and a voltage difference between a cathode and an anode of the zener diode is the withstand voltage of the zener diode.

11. A scan electrode driver for driving a scan electrode of a display device, the scan electrode driver comprising:
a scan IC coupled between a first node and a second node, and adapted to selectively apply a first voltage and a second voltage that is lower than the first voltage to the scan electrode during an address period;
a first transistor including a first end coupled to the first node;
a capacitor coupled between a second end of the first transistor and the second node,
a first resistor coupled to the first end of the first transistor and a control electrode of the first transistor; and
a second resistor coupled to the control electrode of the first transistor and the second end of the first transistor.

12. The scan electrode driver as claimed in claim 11, wherein the capacitor is charged with a third voltage that is lower than a voltage difference between the first voltage and the second voltage before the second voltage is applied to the scan electrode.

13. The scan electrode driver as claimed in claim 11, wherein the first transistor is a MOS (metal oxide semiconductor) field effect transistor.

14. The scan electrode driver as claimed in claim 11, further comprising a diode including a cathode coupled to the first end of the first transistor and an anode coupled to the second end of the first transistor, wherein the first transistor is one of a bipolar transistor and an insulated gate bipolar transistor.

15. The scan electrode driver as claimed in claim 11, further comprising a second transistor coupled between the second node and a power source that supplies the second voltage,
wherein the first node is coupled to a power source that supplies the first voltage.

16. The scan electrode driver as claimed in claim 15, further comprising a third transistor coupled between a power source that supplies a fourth voltage that is higher than the second voltage and the second node, and that is turned on to gradually increase a voltage of the scan electrode during a reset period.

17. The scan electrode driver as claimed in claim 16, wherein the fourth voltage is a high level voltage of a sustain pulse applied to the scan electrode during a sustain period.

18. The scan electrode driver as claimed in claim 16, wherein the third transistor is turned on to gradually increase a voltage of the scan electrode to a voltage that is equal to a sum of the third voltage and the fourth voltage during the reset period.

19. The scan electrode driver as claimed in claim 16, further comprising a fourth transistor coupled between the second node and a power source that supplies a voltage that is lower than the fourth voltage, and that is turned on to gradually decrease a voltage of the scan electrode during a reset period.

20. The scan electrode driver as claimed in claim 11, wherein at least one of the first resistor and the second resistor is a variable resistor.

21. A scan electrode driver for driving a scan electrode, the scan electrode driver comprising:
a scan IC coupled between a first node and a second node, and adapted to selectively apply a first voltage and a second voltage that is lower than the first voltage to the scan electrode during an address period;
a voltage regulator including a first terminal coupled to the first node; and
a capacitor coupled between a second terminal of the voltage regulator and the second node, wherein the voltage regulator is adapted to charge the capacitor with a third voltage that is lower than a voltage difference between the first voltage and the second voltage before the second voltage is applied to the scan electrode.

22. The scan electrode driver as claimed in claim 21, wherein the voltage regulator is one of a zener diode and a voltage multiplier.
